(19) United States
(12) Patent Application Publication
(10) Pub. No.: US 2024/0320050 A1
(43) Pub. Date: Sep. 26, 2024

(54) N-WAY FAULT TOLERANT PROCESSING SYSTEM

(71) Applicant: ADVANCED MICRO DEVICES, INC., Santa Clara, CA (US)

(72) Inventors: Patrick Pok Man Lai, Fremont, CA (US); Vilas Sridharan, Boston, MA (US); Jay Fleischman, Merrill, WI (US)

(21) Appl. No.: 18/126,139

(22) Filed: Mar. 24, 2023

(51) Int. Cl. G06F 9/50; G06F 9/38

(52) U.S. Cl. CPC G06F 9/5044; G06F 9/3861; G06F 9/5077

(57) ABSTRACT

A processor includes two or more core dies each including one or more processor cores. A first core die of the processor is associated with a first operating system and the processor cores of the first core die execute a set of instructions according to the first operating system to produce a first result. A second core of the processor is associated with a second operating system and the processor cores of the second core of the second core die execute the set of instructions according to the second operating system to produce a second result. The first and second core dies provide the first and second results to a voting circuitry that generates an output based on the first and second results.

### BACKGROUND

Processing systems run one or more operating systems configured to manage and allocate the hardware and software resources of the processing system to support the execution of applications. Additionally, the processing system includes one or more processors (e.g., central processing units) each having an architecture defined by one or more instruction set architectures (ISAs) to execute instructions for these applications. However, certain operating systems used to manage the applications, certain ISAs of the processors configured to execute instructions for the applications, or both can introduce errors or security vulnerabilities into the processing system when an application is executed. For example, certain ISAs increase the risk of transient execution attacks and microarchitecture data sampling into the processing system, decreasing the security and reliability of the processing system. As another example, an operating system controlled by a malicious entity can remap memory addresses or replace function calls, increasing the risk that data in the processing system is exposed to one or more malicious entities and increasing the risk that one or more errors occur when instructions for the application are executed.

### BRIEF DESCRIPTION OF THE DRAWINGS

The present disclosure may be better understood, and its numerous features and advantages are made apparent to those skilled in the art by referencing the accompanying drawings. The use of the same reference symbols in different drawings indicates similar or identical items.

FIG. 1 is a block diagram of a processing system 100 implementing N-way fault tolerance, in accordance with some implementations.

FIG. 2 is a block diagram of a central processing unit (CPU) implementing an N-way redundant framework, in accordance with some implementations.

FIG. 3 is a block diagram of an example CPU implementing an N-way operating system redundant framework, in accordance with some implementations.

FIG. 4 is a block diagram of an example CPU an N-way hardware redundant framework, in accordance with some implementations.

FIG. 5 is a block diagram of an example CPU an N-way hardware redundant framework, in accordance with some implementations.

FIG. 6 is a flow diagram illustrating an example method for implementing N-way fault tolerance, in accordance with some implementations.

### DETAILED DESCRIPTION

To support the execution of applications by a processing system, the processing system runs one or more operating systems configured to manage (e.g., allocate, configure) resources (e.g., hardware resources, software resources) of the processing system to perform instructions, workloads, and operations for the application. However, certain operating systems running on the processing system can introduce errors and security vulnerabilities into the processing system. As an example, an interaction between the operating system and an application (e.g., how resources are allocated to the application) can introduce one or errors (e.g., incorrect values) when a processor executes instructions for the application, decreasing the reliability of the processing system. As another example, operating systems controlled by a malicious entity introduce security vulnerabilities by remapping memory addresses (e.g., page tables), altering memory requests (e.g., direct memory access (DMA) requests, memory-mapped I/O (MMIO) requests), replacing function calls, and the like. These security vulnerabilities, for example, increase the risk that data in the processing system is exposed to one or more malicious entities, decreasing the security of the processing system.

Additionally, to support the execution of one or more applications, a processing system includes one or more processors each including one or more processor cores configured to execute instructions, workloads, and operations for the applications and configured to store data resulting from the execution of the instructions, workloads, and operations in, for example, a memory of the processing system. The architectures of these processors (e.g., the architecture of the processor cores of the processors) are defined by an instruction set architecture (ISA) that indicates the instructions, data types, registers, memory management, memory consistency, addressing modes, virtual memory, input/output models, or any combination thereof supported by the architecture of a processor, how machine code behaves on the architecture of a processor, or both. However, executing instructions for some applications on processors defined by certain ISAs can introduce errors and security vulnerabilities (e.g., transient execution attacks, microarchitecture data sampling) into the processing system due to the architectures (e.g., processor architectures) of the ISAs, decreasing the security and reliability of the processing system.

To this end, systems and techniques disclosed herein are directed to a processing system implementing N-way fault tolerance. To this end, the processing system includes a central processing unit (CPU) that includes one or more core dies (e.g., core chiplet dies). Each core die, for example, includes one or more processor cores each configured to execute instructions, workloads, operations, or any combination thereof for an application executed by the processing system. To support N-way fault tolerance, one or more core dies of the CPU are each associated with a respective operating system, respective ISA, or both that is different from an operating system, ISA, or both associated with one or more other core dies of the CPU. For example, in implementations, the CPU includes a first core die associated with a first operating system and a second core die associated with a second operating system that is different from the first operating system. As another example, the CPU includes a first core die associated with (e.g., having processor cores defined by) a first ISA and a second core die associated with a second ISA that is different from the first ISA.

According to implementations, each core die (e.g., the processor cores of each core die) of the CPU is configured to concurrently execute a same set of instructions, workloads, operations, or any combination thereof for an application. For example, each core die is configured to execute a same set of instructions, workloads, operations, or any combination thereof for an application such that a result (e.g., data resulting from the execution of instructions, workloads, or operations) based on the respective operating system and ISA associated with the core die is produced. Because one or more core dies of the CPU are each associated with a respective operating system, respective ISA, or both that is different from an operating system, ISA, or both associated with one or more other core dies of the CPU, the core dies together generate multiple results each based on a respective operating system, ISA, or both (e.g., the operating system and ISA of the core die that generated the result). In this way, results based on different operating systems, ISAs, or both are produced. For example, a first result based on a first operating system, first ISA, or both is produced and a second result based on a second operating system, second ISA, or both is produced, wherein the first and second operating systems are different from each other and wherein the first and second ISAs are different from one another.

After generating a result, each core die is configured to provide the result to a voting circuitry included in or otherwise connected to the CPU and configured to determine an output of the CPU based on results received from two or more core dies. In response to receiving results from two or more core dies, the voting circuitry determines an output of the CPU based on, for example, the received results. For example, to determine an output, the voting circuitry is configured to determine a majority result from the received results (e.g., the most frequently occurring, or mode, result within the received results), a minority result from the received results (e.g., the least frequently occurring result within the received results), or both. In this way, the processing system implements N-way fault tolerance to help minimize errors, security vulnerabilities, or both introduced into the processing system by certain operating systems, ISA, or both. As an example, in implementations, three or more core dies of a CPU are each associated with a respective operating system, ISA, or both that is different from the operating system, ISA, or both associated with one or more other core dies of the CPU. These core dies each execute a same set of instructions and provide the results to a voting circuitry that then determines a majority result to determine an output for CPU. As such, if one of the core dies provides an incorrect result due to one or more errors, security vulnerabilities, or both introduced by a certain operating system, ISA, or both associated with the core die, the voting circuitry still determines a correct output by determining the majority result and disregarding the incorrect result. Because the incorrect result is discarded, the security and reliability of the processing system are improved.

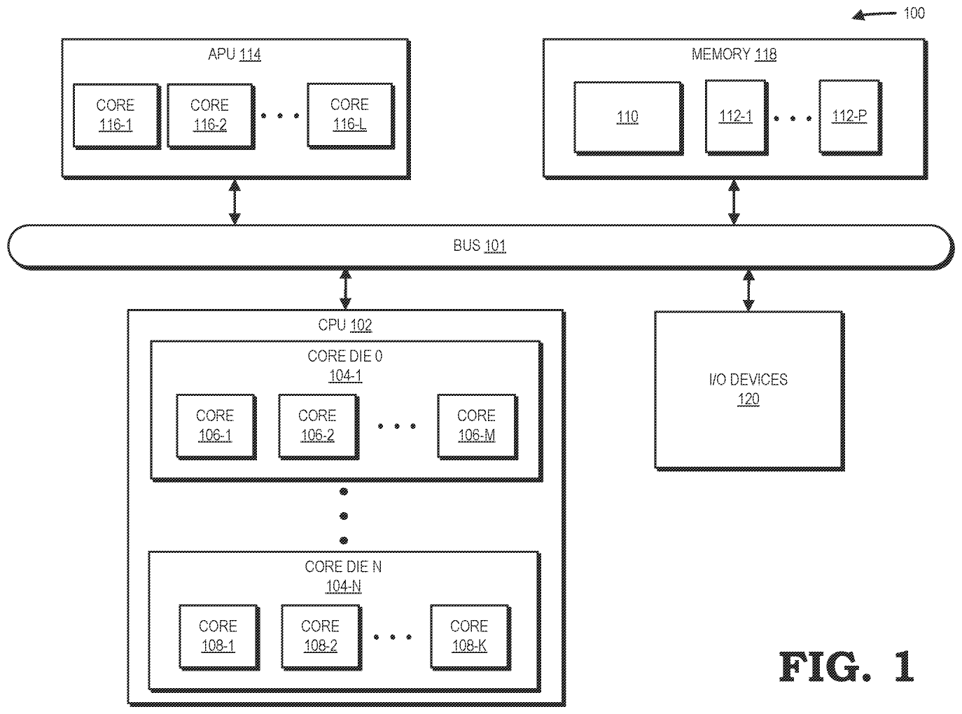

FIG. 1 is a block diagram of a processing system 100 implementing N-way fault tolerance, according to some implementations. As an example, the processing system 100 includes a server system (e.g., one or more physical servers, virtual servers) configured to execute one or more applications (e.g., machine-learning applications, artificial intelligence (AI) applications, deep learning applications, shader applications, High-performance computing (HPC) applications, data center applications, cloud computing applications). To support the execution of such applications, the processing system 100 includes or has access to memory 118 or other storage component implemented using a non-transitory computer-readable medium, for example, a dynamic random-access memory (DRAM). However, in implementations, memory 118 is implemented using other types of memory including, for example, static random-access memory (SRAM), double data rate SDRAM (DDR SRAM), nonvolatile RAM, and the like. According to implementations, memory 118 includes an external memory implemented external to the processing units implemented in the processing system 100. The processing system 100 also includes a bus 101 to support communication between entities implemented in the processing system 100, such as the memory 118, accelerated processing unit (APU) 114, central processing unit (CPU) 102, input/output (I/O) devices 120, or any combination thereof.

In implementations, memory 118 is configured to store one or more operating systems 112 to support the execution of one or more applications. Such operating systems 112, for example, include data (e.g., program code) indicating one or more operations, instructions, or both to support the execution of applications by processing system 100. These operations and instructions include, for example, scheduling tasks (e.g., workloads, instructions) for one or more applications, allocating resources (e.g., registers, local data shares, scratch memory) to tasks for one or more applications, providing an interface to I/O devices 120 (e.g., hard disks, network interface controller, modem) for one or more applications, or any combination thereof. Though the example implementation illustrated in FIG. 1 presents memory 118 as storing two operating systems (112-1, 112-P) representing a P number of operating systems 112, in other implementations, memory 118 can store any number of operating systems 112.

Further, to support the execution of one or more applications, processing system 100 includes CPU 102. CPU 102 includes, for example, any of a variety of parallel processors, vector processors, coprocessors, non-scalar processors, highly parallel processors, artificial intelligence (AI) processors, inference engines, machine learning processors, other multithreaded processing units, scalar processors, serial processors, or any combination thereof. As an example, CPU 102 includes one or more dies (e.g., core dies 104, core chiplet dies) each including one or more parallel processors, vector processors, coprocessors, non-scalar processors, highly parallel processors, AI processors, inference engines, machine learning processors, other multithreaded processing units, scalar processors, serial processors, or any combination thereof. In implementations, CPU 102 is configured to receive and execute one or more instructions for one or more applications executed by processing system 100.

In implementations, memory 118 includes program code 110 for one or more applications executed by processing system 100. Such program code 110, for example, includes data indicating one or more workloads, instructions, operations, or any combination thereof to be performed for one or more applications. As an example, program code 110 includes data indicating one or more instructions for an AI application, machine learning application, HPC application, or any combination thereof to be executed by processing system 100. According to implementations, CPU 102 is configured to receive one or more instructions from program code 110 and, using a plurality of processor cores (e.g., processor cores 106, 108), is configured to perform one or more operations for the instructions (e.g., one or more operations indicated in the instructions). To this end, CPU 102 includes two or more core dies 104 (e.g., core chiplet dies) that each include one or more processor cores (e.g., one or more integrated circuits (ICs) that each include one or more processor cores). As an example, the implementation illustrated in FIG. 1 presents CPU 102 having two core dies (104-1, 104-N) representing an N number of core dies 104 with a first core die 0 104-1 including three processor cores (106-1, 106-2, 106-M) representing an M number of processor cores 106 and a second core die N 104-N including three processor cores (108-1, 108-2, 108-K) representing a K number of processor cores 108. Although the example implementation in FIG. 1 presents CPU 102 as having two core dies (104-1, 104-N) representing an N number of core dies, in other implementations, CPU 102 can include any number of core dies 104. Additionally, though the example implementation in FIG. 1 presents each core die 104 as having three processor cores (106-1, 106-2, 106-M, 108-1, 108-2, 108-K) representing an M and K number of processor cores 106, 108 respectively, in other implementations each core die 104 can include any number of processor cores. For example, in implementations, a first core die 104 has a same number of processor cores as one or more other core dies 104, a first core die 104 has a different number of processor cores as one or more other core dies 104, or both.

According to implementations, to perform one or more operations for one or more instructions of an application executed by processing system 100, one or more processor cores 106, 108 of one or more core dies 104 of CPU 102 each operate as a compute unit. These compute units each include one or more single instruction, multiple data (SIMD) units that perform the same operation on different data sets to produce one or more results. Such results, for example, include data resulting from the performance of one or more operations by one or more processor cores 106, 108. After producing one or more results, a compute unit is then configured to store the results in a cache within or otherwise coupled to the compute unit (e.g., the processor core 106, 108 operating as a compute units), memory 118, or both. Additionally, in implementations, to execute one or more instructions, perform one or more instructions, or both of an application executed by processing system 100, one or more processor cores 106, 108 of a core die 104 are configured to support one or more instruction set architectures (ISAs). Such ISAs, for example, include models indicating the instructions, data types, registers, memory management, virtual memory management, I/O models, or any combination thereof supported by one or more processors (e.g., by one or more processor cores 106, 108 of a core die 104). That is to say, one or more processor cores 106, 108 of a core die 104 include an architecture configured to support instruction sets defined by one or more ISAs. As an example, one or more processor cores 106, 108 of one or more core dies 104 include an architecture to support instruction sets defined by a complex instruction set (CISC) ISA (e.g., x86). As another example, one or more processor cores 106, 108 of one or more core dies 104 include an architecture to support instruction sets defined by a reduced instruction set (RISC) ISA (e.g., Advanced RISC Machines (ARM)).

In this way, one or more processor cores 106, 108 of one or more core dies 104 of CPU 102 are configured to execute instructions, execute workloads, perform operations, or any combination thereof for one or more applications being executed by processing system 100. However, executing instructions for some applications on processor cores 106, 108 associated with certain ISAs (e.g., x86, ARM) can introduce errors and security vulnerabilities (e.g., transient execution attacks, microarchitecture data sampling) into processing system 100 due to the architectures (e.g., processor architectures) associated with the ISAs, how instructions sets (e.g., kernel code) are executed according to the ISAs, or both. Additionally, certain operating systems 112 supporting the execution of instructions for one or more applications can also introduce errors and security vulnerabilities into processing system 100. For example, operating systems 112 controlled by a malicious entity introduce security vulnerabilities by remapping memory addresses (e.g., page tables), altering memory requests (e.g., direct memory access (DMA) requests, memory-mapped I/O (MMIO) requests), replacing function calls, and like.

To help reduce the likelihood of such errors and security vulnerabilities in processing system 100, CPU 102 is configured to implement an N-way fault tolerance To implement N-way fault tolerance, one or more core dies 104 of CPU 102 each include processor cores 106, 108 associated with a respective ISA, respective operating system 112, or both that is different from the ISA, operating system 112, or both associated with one or more other core dies 104 of CPU 102. For example, in some implementations, a first core die 104-1 of CPU 102 includes processor cores 106 having an architecture associated with a first ISA (e.g., x86) and a second core die 104-N of CPU 102 includes processor cores 108 having an architecture associated with a second ISA (e.g., ARM). As another example, a first core die 104-1 of CPU 102 includes processor cores 106 configured to execute instructions for a first operating system 112-1 (e.g., execute instructions as managed by the first operating system 112-1) and a second core die 104-N of CPU 102 includes processor cores 108 configured to execute instructions for a second operating system 112-P that is different from the first operating system 112-1. As yet another example, a first core die 104-1 of CPU 102 includes processor cores 106 having an architecture associated with a first ISA (e.g., x86) and configured to execute instructions for a first operating system 112-1 and a second core die 104-N of CPU 102 includes processor cores 108 having an architecture associated with a second ISA (e.g., ARM) and configured to execute instructions for a second operating system 112-P that is different from the first operating system 112-1.

To execute different operating systems 112 on different core dies 104 of CPU 102, processing system 100 is configured to execute two or more virtual machines (VMs) each associated with a respective operating system 112. That is to say, processing system 100 executes two or more VMs that each run a respective operating system 112. For example, processing system 100 executes a first VM running a first operating system 112-1 and a second VM running a second operating system 112-P, wherein the first operating system 112-1 is different from the second operating system 112-P. To help support the VMs, in implementations, one or more core dies 104 of CPU 102 are configured to function as a hypervisor (e.g., system manager). Such a hypervisor, for example, includes hardware-based circuitry, software-based circuitry, or both configured to create and manage the VMs executed by processing system 100. For example, a core die 104 includes one or more processor cores 104, 106 configured to perform instructions, commands, operations, or any combination thereof to create and manage the VMs executed by processing system 100.

In implementations, one or more processor cores 104, 106 of a core die 104 functioning as a hypervisor are configured to allocate a core die 104 of CPU 102 to a VM executed by processing system 100. For example, one or more processor cores 104, 106 of a core die 104 functioning as a hypervisor are configured to allocate a first core die 0 104-1 to a first VM running a first operating system 112-1. After a core die 104 is allocated to a VM, one or more processor cores 104, 106 of the core die 104 are configured to execute one or more instructions, workloads, operations, or any combination thereof for one or more applications (machine-learning applications, AI applications, deep learning applications, shader applications, HPC applications, data center applications, cloud computing applications) being executed by the VM, processing system 100, or both based on (e.g., as managed by) the operating system 112 running on the VM. As an example, after core die 0 104-1 is allocated to a first VM running a first operating system 112-1, one or more processor cores of core die 0 104-1 are configured to execute one or more instructions, workloads, operations, or any combination thereof for an application based on the first operating system 112-1. Because each core die 104 of CPU 102 is allocated to a respective VM that runs a respective operating system 112, the core dies 104 of CPU 102 are configured to execute instructions, workloads, and operations based on two or more different operating systems 112 concurrently.

Additionally, in some implementations, to implement N-way fault tolerance, one or more core dies 104 of CPU 102 have programmable hardware configured to perform one or more instructions, workloads, operations, or any combination thereof for one or more applications executed by processing system 100. Such programmable hardware includes one or more programmable logic devices, for example, Simple Programmable Logic Devices (SPLDs), Complex Programmable Logic Devices (CPLDs), Field-Programmable Gate Arrays (FPGAs), and the like. For example, in implementations, one or more core dies 104 of CPU 102 include one or more FPGAs configured to perform one or more instructions, workloads, operations, or any combination thereof for one or more applications executed by processing system 100. In response to performing one or more instructions, workloads, or operations, one or more programmable logic devices are configured to store results (e.g., data resulting from the performance of the instructions, workloads, or operations) in, for example, memory 118. In some implementations, CPU 102 includes one or more core dies 104 each associated with a respective ISA and operating system 112 (e.g., core dies 104 having processor cores 104, 106 associated with a respective ISA) and one or more core dies 104 that each include one or more programmable logic devices (e.g., FPGAs).

In implementations, to implement N-way fault tolerance, two or more core dies 104 of CPU 102 are configured to execute the same workloads, instructions, operations, or any combination thereof for one or more applications in parallel. That is to say, the processor cores 106, 108 of each core die 104 are configured to perform the same workloads, instructions, operations, or any combination thereof for the same application concurrently. As such, within the N-way redundant framework, instructions, workloads, and operations for an application are executed on two or more core dies 104 each associated with a respective operating system 112 (e.g., each allocated to a respective VM running a respective operating system 112 executing the application), ISA, or both. In other words, instructions, workloads, and operations for an application are executed on two or more core dies 104 concurrently such that the instructions, workloads, and operations are executed according to two or more operating systems 112 (e.g., operating systems 112 of the VMs allocated to respective core dies 104), two or more ISAs (e.g., ISAs associated with respective core dies 104), or both. As an example, the processor cores 106 of a first core die 104-1 are configured to perform instructions for an application executed by a first VM running a first operating system 112-1 and the processor cores 108 of a second core die 104-2 are configured to perform the same instructions for the application executed by a second VM running a second operating system 112-P. As another example, the processor cores 106 of a first core die 104-1 having an architecture associated with a first ISA are configured to perform instructions for an application and the processor cores 108 of a second core die 104-N having an architecture associated with a second ISA are configured to perform the same instructions for the application. Further, in some implementations, instructions, workloads, and operations for an application are executed on a core die having one or more programmable logic devices in addition to two or more core dies 104 each associated with a respective operating system 112 (e.g., each allocated to a respective VM running a respective operating system 112 executing the application), ISA, or both. For example, CPU 102, in implementations, includes a first core die 104 having one or more programmable logic devices (e.g., FPGAs) configured to perform instructions for an application, a second core die 104 having processor cores 106, 108 associated with a first ISA (e.g., x86) configured to perform instructions for the application, and a third core die 104 having processor cores 106, 108 associated with a second ISA (e.g., ARM) configured to perform instructions for the application.

According to implementations, in response to one or more processor cores 106, 108, programmable logic devices, or both of a core die 104 completing the execution of one or more instructions, workloads, operations, or any combination thereof, one or more processor cores 106, 108, programmable logic devices, or both of the core die 104 are configured to provide results (e.g., data resulting from the execution of the one or more instructions, workloads, operations, or any combination thereof) to a voting circuitry. Such voting circuitry, for example, includes hardware-based circuitry, software-based circuitry, or both configured to determine an output based on two or more received results from two or more core dies 104. In some implementations, voting circuitry is included in a core die 104 (e.g., one or more processor cores 106, 108 of a core die 104 operate as the voting circuitry) while in other implementations CPU 102 is otherwise connected to the voting circuitry. In response to receiving results from two or more core dies 104 each resulting from the execution of the same instructions, workloads, operations, or any combination thereof, the voting circuitry is configured to determine an output based on, for example, the received results. For example, to determine an output, the voting circuitry (e.g., including a majority logic gate) is configured to determine a majority result from the received results (e.g., the most frequently occurring, or mode, result within the received results), a minority result from the received results (e.g., the least frequently occurring result within the received results), or both. In this way, CPU 102 implements N-way fault tolerance to help minimize errors, security vulnerabilities, or both introduced into processing system 100 by one or more operating systems 112, ISAs, or both. For example, in implementations, three or more cores dies 104 of CPU 102 each associated with a respective operating system 112, ISA, or both, each execute a same set of instructions and provide the results to a voting circuitry. The voting circuitry then determines a majority result (e.g., the most frequently occurring, or mode, result within the received results) to determine an output for CPU 102. In this way, if one of the core dies 104 of CPU 102 provides an incorrect result due to one or more errors, security vulnerabilities, or both introduced by the operating system 112, ISA, or both associated with the core die 104, the voting circuitry still determines a correct output by determining the majority result and disregarding the incorrect result. As such, the security and fault tolerance of the processing system 100 is improved as the voting security helps ensure errors introduced by certain operating systems 112, ISAs, or both do not impact the output of CPU 102.

The processing system 100 also includes an APU 114 that is connected to the bus 101 and therefore communicates with the CPU 102 and the memory 118 via the bus 101. The APU 114 implements a plurality of processor cores 116-1 to 116-N that execute instructions concurrently or in parallel. In implementations, one or more of the processor cores 116 each operate as one or more compute units (e.g., SIMD units) that perform the same operation on different data sets. Though in the example implementation illustrated in FIG. 1, three processor cores (116-1, 116-2, 116-L) are presented representing an L number of cores, the number of processor cores 116 implemented in APU 114 is a matter of design choice. As such, in other implementations, APU 114 can include any number of processor cores 116. The processor cores 116 execute instructions such as program code 110 (e.g., a shader program) stored in memory 118, and APU 114 stores information in memory 118 such as the results of the executed instructions (e.g., instructions from a shader program).

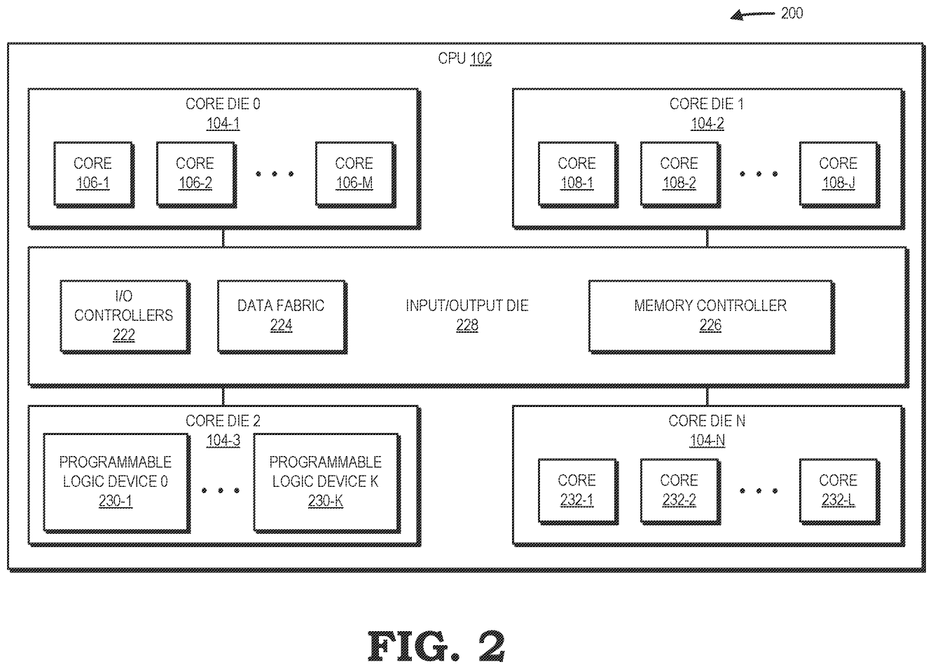

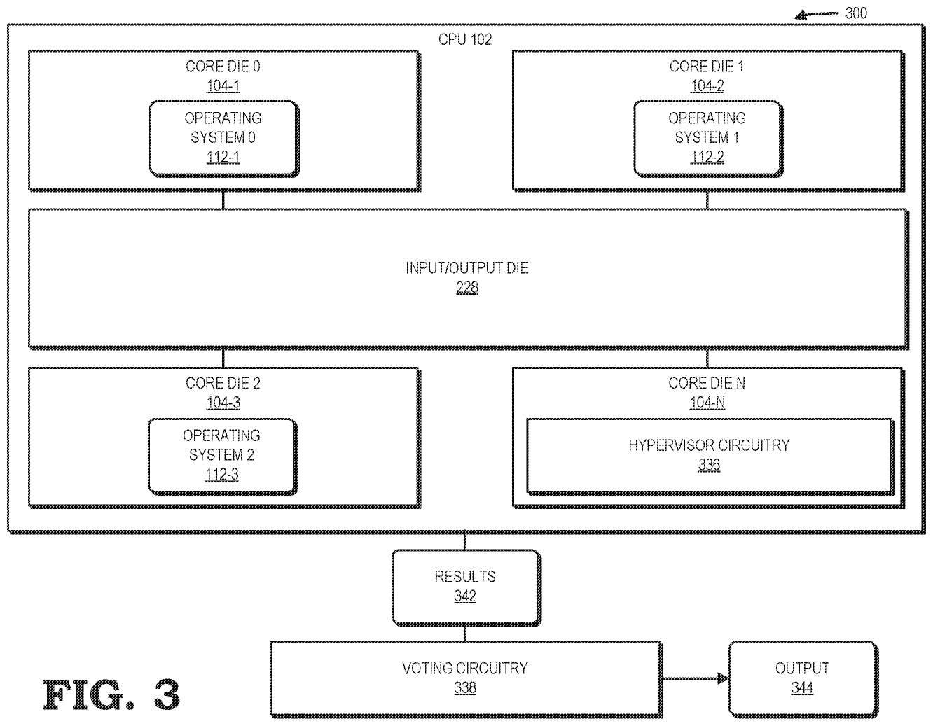

Referring now to FIG. 2, CPU 102 implementing an N-way redundant framework 200 is presented. In implementations, CPU 102 implementing an N-way redundant framework 200 includes, for example, core die 0 104-1, core die 1 104-2, core die 2 104-3, core die N 104-N, input/output (I/O) die 228, or any combination thereof. Though the example implementation illustrated in FIG. 2 presents CPU 102 as having four core dies (104-1, 104-2, 104-3, 104N) representing an N number of core dies 104, in other implementations, CPU 102 may have any number of core dies 104. According to implementations, one or more core dies 104 each includes one or more processor cores, similar to or the same as processor cores 106, 108, configured to execute one or more instructions, workloads, operations, or any combination thereof for one or more applications being executed by processing system 100, VM, or both. As an example, referring to the implementation illustrated in FIG. 3, CPU 102 includes a first core die 0 104-1 that includes three processor cores (106-1, 106-2, 106-M) representing an M number of processor cores, a second core die 1 104-2 that includes three processor cores (108-1, 108-2, 108-J) representing a J number of processor cores, and a third core die N 104-N that includes three processor cores (232-1, 232-2, 232-L) representing an L number of processor cores. Though the example implementation illustrated in FIG. 2 presents the core dies 104-1, 104-2, 104-N as having three processor cores, in other implementations, each core die 104 may have any respective number of processor cores. Additionally, in implementations, two or more core dies 104 of CPU 102 have an equal number of processor cores, two or more core dies 104 of CPU 102 have a different number of processor cores, or both. Further, in implementations, one or more core dies 104 of CPU 102 include one or more programmable logic devices 230. Such programmable logic devices 230 include, for example, SPLDs, CPLDs, FPGAs, or any combination thereof, to name a few. Though the example implementation illustrated in FIG. 2 presents core die 2 104-3 as having two programmable logic devices (230-1, 230-K) representing a K number of programmable logic devices, in other implementations, a core die 104 can include any number of programmable logic devices 230.

According to implementations, one or more core dies 104 are configured to operate as a hypervisor. That is to say, one or more processor cores 106, 108, 232 of a core die 104 are configured to create and manage one or more VMs executed by processing system 100 that each run a respective operating system 112. To this end, a core die 104 functioning as a hypervisor is configured to allocate one or more other core dies 104 of CPU 102 to one or more VMs each running a respective operating system 112. After being allocated to a VM running a respective operating system 112, the processor cores 106, 108, 232 of the allocated core die 104 are configured to perform instructions, workloads, operations, or any combination thereof for one or more applications executed by the VM based on (e.g., as managed by) the operating system 112 running on the VM. By allocating VMs running different operating systems to respective core dies 104, two or more core dies 104 are each associated with different operating systems 112. That is to say, the processor cores 106, 108, 232 of two or more core dies 104 are each configured to execute instructions, workloads, operations, or any combination thereof for an application as managed by different operating systems 112.

In implementations, one or more core dies 104 of CPU are each associated with a respective operating system 112 (e.g., are allocated to a respective VM running a respective operating system 112), a respective ISA (e.g., the processor cores 106, 108, 232 of the core die 104 have an architecture defined by a respective ISA), include one or more programmable logic devices 230, or any combination thereof. For example, in implementations, two or more core dies 104 of CPU are each associated with respective, different operating systems 112 (e.g., each core die 104 is allocated to a respective VM running a respective, different operating system 112), two or more core dies 104 are each associated with respective, different ISAs, one or more core dies 104 include one or more programmable logic devices (e.g., FPGAs), or any combination thereof. In this way, CPU 102 is configured to execute a same set of instructions, workloads, operations, or any combination thereof for one or more applications concurrently using one or more operating systems 112, ISAs, programmable devices 230, or any combination thereof. As an example, CPU 102 is configured to concurrently execute a set of instructions for an application on a first core die 0 104-1 including processor cores 106 associated with a first operating system 112-1 (e.g., processor cores 106 are configured to execute instructions, workloads, and operations as managed by the operating system 112-1), a second core die 1 104-2 including processor cores 108 associated with a second operating system 112-P, and a third core die 2 104-2 having one or more programmable logic devices 230, wherein the first operating system 112-1 and the second operating system 112-P are each different from each other. As another example, CPU 102 is configured to concurrently execute a set of instructions for an application on a first core die 0 104-1 including processor cores 106 associated with a first ISA (e.g., processor cores 106 having an architecture based on the first ISA) and a second core die 1 104-2 including processor cores 108 associated with a second ISA, wherein the first and second ISA are different. As yet another example, CPU 102 is configured to concurrently execute a same set of instructions on a first core die 0 104-1 including processor cores 106 associated with a first operating system 112-1 and a first ISA and a second core die 1 104-2 including processor cores 108 associated with a second operation system 112-P and a second ISA, wherein the first operating system 112-1 and the second operating system 112-P are different and wherein the first and second ISAs are different.

To help support the execution of instructions, workloads, and operations on CPU 102, CPU 102 includes I/O die 228 connected to each of the core dies 104. I/O die 228 includes hardware-based circuitry, software-based circuitry, or both configured to provide an interface between core dies 104 and memory 118, one or more I/O devices 120, or both. To this end, I/O die 228 includes or is otherwise connected to data fabric 224 which includes hardware-based circuitry, software-based circuitry, or both that provides an interconnect architecture between core dies 104, I/O die 228 (e.g., I/O controllers 222, memory controller 226), memory 118, one or more I/O devices 120, bus 101, or any combination thereof. As an example, data fabric 224 provides an interconnect architecture between core dies 104, memory controller 226, and memory 118. As another example, data fabric 224 provides an interconnect architecture between core dies 104, one or more I/O controllers 222, and one or more I/O devices 120. Additionally, to provide an interface between core dies 104 and memory 118, I/O die 228 includes memory controller 226. Memory controller 226 includes, for example, hardware-based circuitry, software-based circuitry, or both configured to access, modify, and delete data in memory 118. For example, memory controller 226 is configured to access, modify, and delete data in memory 118 to help manage read operations, write operations, fetch operations, pre-fetch operations, copy operations, or any combination thereof between core dies 104 and memory 118. Further, to provide an interface between core dies 104 and one or more I/O devices 120, I/O die 228 includes one or more I/O controllers 222. Such I/O controllers 222 each include, for example, hardware-based circuitry, software-based circuitry, or both configured to manage data transfers (e.g., memory access requests) between core dies 104, memory 118, and one or more I/O devices 120. For example, an I/O controller 222 is configured to manage direct memory access (DMA) requests from an I/O device 120 to access memory 118. As another example, an I/O controller 222 is configured to manage memory-mapped input/output (MMIO) requests from one or more core dies 104 to access a memory or registers of an I/O device 120.

According to some implementations, one or more core dies 104 of CPU 102 function as voting circuitry while in other implementations CPU 102 is otherwise connected to such voting circuitry. The voting circuitry, for example, includes hardware-based circuitry, software-based circuitry, or both configured to determine an output of CPU 102 based on two or more received results (e.g., data resulting from the execution of one or more instructions, workloads, operations, or any combination thereof of an application executed by processing system 100, a VM, or both) from two or more core dies 104. As an example, in implementations, one or more core dies 104 each include one or more processor cores 106, 108, 232 configured to determine an output based on results received from two or more other core dies 104. To this end, in response to receiving results from two or more core dies 104 each resulting from the execution of the same instructions, workloads, operations, or any combination thereof for an application, one or more processor cores 106, 108, 232 of a core die 104 operating as voting circuitry are configured to determine an output of CPU 102 by, for example, determining a majority result from the received results (e.g., the most frequently occurring, or mode, result within the received results), a minority result from the received results (e.g., the least frequently occurring result within the received results), or both. In this way, CPU 102 implements N-way redundant framework 200 to help minimize errors, security vulnerabilities, or both introduced into processing system 100 by one or more operating systems 112, ISAs, or both.

Referring now to FIGS. 3 to 5, a CPU 102 implementing example N-way redundant frameworks is presented. In implementations, the example N-way operating system redundant framework 300 includes CPU 102 having core die 0 104-1, core die 1 104-2, core die 2 104-3, and core die 104-N. Additionally, to provide an interface between the core dies 104 and memory 118, one or more I/O devices 120, or both, CPU 102 includes I/O die 228. Though the example implementations presented in FIGS. 3 to 5 present CPU 102 as having four core dies (104-1, 104-2, 104-3, 104-N) representing an N number of core dies 104, in other implementations, CPU 102 can have any number of core dies 104.

In implementations, processing system 100 is configured to execute one or more VMs. Each VM executed by processing system 100, for example, is configured to run a respective operating system 112. As an example, one or more VMs executed by processing system 100 are configured to run an operating system 112 that is different from one or more operating systems 112 run by one or other VMs. Additionally, each VM is configured to execute an application as managed by the operating system 112 running on the VM. According to implementations, one or more core dies 104 of CPU 102 are configured to function as a hypervisor configured to create and manage the VMs executed by processing system 100. That is to say, one or more core dies 104 run the hypervisor, system management programs, or both for processing system 100. To this end, a core die 104 (e.g., core die N 104-N) includes hypervisor circuitry 336 that includes hardware-based circuitry, software-based circuitry, or both configured to create and manage VMs. For example, hypervisor circuitry 336 includes one or more processor cores 106, 108, 232 configured to execute instructions, commands, operations, or any combination thereof to create and manage VMs. According to implementations, hypervisor circuitry 336 is configured to allocate one or more core dies 104 to one or more respective VMs being executed on processing system 100. In some implementations, hypervisor circuitry 336 is configured to allocate an equal number of core dies 104 to each VM executed by processing system 100, while in other implementations hypervisor circuitry 336 is configured to allocate a different number of core dies 104 to two or more VMs executed by processing system 100.

Referring now to FIG. 3, CPU 102 implementing an N-way operating system redundant framework 300 is presented. Because each VM runs a respective operating system 112, within N-way operating system redundant framework 300, hypervisor circuitry 336 is configured to allocate core dies 104 to the VMs such that two or more core dies 104 are associated with different operating systems 112. That is to say, hypervisor circuitry 336 is configured to allocate one or more core dies 104 to a first VM running a first operating system 112 and one or more other core dies 104 to one or more other VMs each running respective operating systems 112 that are different from the first operating system 112, one or more operating systems 112 run by other VMs, or both. For example, hypervisor circuitry 336 is configured to allocate a first core die 0 104-1 to a first VM running a first operating system 0 112-1, a second core die 1 104-2 to a second VM running a second operating system 1 112-2, and a third core die 2 104-3 to a third VM running a third operating system 2 112-3, wherein the first operating system 112-1, second operating system 112-2, and third operating system 112-3 are each different from each other. After being allocated to a VM running a respective operating system 112, a core die 104 (e.g., the processor cores 106, 108, 232 of the core die 104) is configured to execute instructions, workloads, operations, or any combination thereof for an application executed by the VM based on the operating system 112 running on the VM. In implementations, each core die 104 is allocated to a respective VM running the same application. In this way, each core die 104 associated with a respective operating system 112 is configured to execute to the same instructions, workloads, operations, or any combination thereof for the same application concurrently. In other words, two or more core dies 104 of CPU 102 concurrently execute the same instructions, workloads, operations, or any combination thereof for an application according to (e.g., as managed by) two or more respective operating systems 112 (e.g., the operating systems 112 associated with each core die 104). As such, CPU 102 is configured to execute the same instructions, workloads, operations, or any combination thereof for an application according to different operating systems 112.

In response to executing one or more instructions, workloads, operations, or any combination thereof for an application, each core die 104 is configured to provide results 342 (e.g., data resulting from the execution of the instructions, workloads, operations, or any combination thereof) to voting circuitry 338 included in or otherwise connected to CPU 102. That is to say, the core dies 104 provide results 342 from the execution of a same set of instructions, workloads, operations, or any combination thereof according to (e.g., as managed by) two or more operating systems 112 (e.g., the operating systems 112 associated with each core die 104 providing results 342). Voting circuitry 338 includes, for example, hardware-based circuitry, software-based circuitry, or both configured to determine an output 344 for CPU 102 based on, for example, the received results 342 (e.g., the results 342 received from each core die 104 associated with a respective operating system 112). For example, to determine an output 344, the voting circuitry (e.g., including a majority logic gate) is configured to determine a majority result from the received results 342 (e.g., the most frequently occurring, or mode, result within the received results 342), a minority result from the received results 342 (e.g., the least frequently occurring result within the received results 342), or both. In this way, CPU 102 implements an N-way operating system redundant framework 300 to help minimize errors, security vulnerabilities, or both introduced into processing system 100 by one or more operating systems 112. For example, in implementations, CPU 102 includes a first core die 0 104-1 associated with a first operating system 0 112, a second core die 1 104-2 associated with a second operating system 1 112-2, and a third core die 2 104-3 associated with a third operating system 2 112-3 each configured to execute a same set of instructions for an application. In response to executing the set of instructions, each core die 104 is configured to provide the result (e.g., data resulting from the execution of the set of instructions) to voting circuitry 338. Voting circuitry 336 then determines a majority result (e.g., the most frequently occurring, or mode, result within the received results 342) to determine an output 344 for CPU 102. In this way, if one of the core dies 104 of CPU 102 provides an incorrect result due to one or more errors, security vulnerabilities, or both introduced by an operating system (e.g., operating system 0 112-1, operating system 1 112-2, operating system 2 112-3) associated with the core die 104, the voting circuitry still determines a correct output 344 by determining the majority result and disregarding the incorrect result caused by the operating system 112 introducing one or more errors, security vulnerabilities, or both.

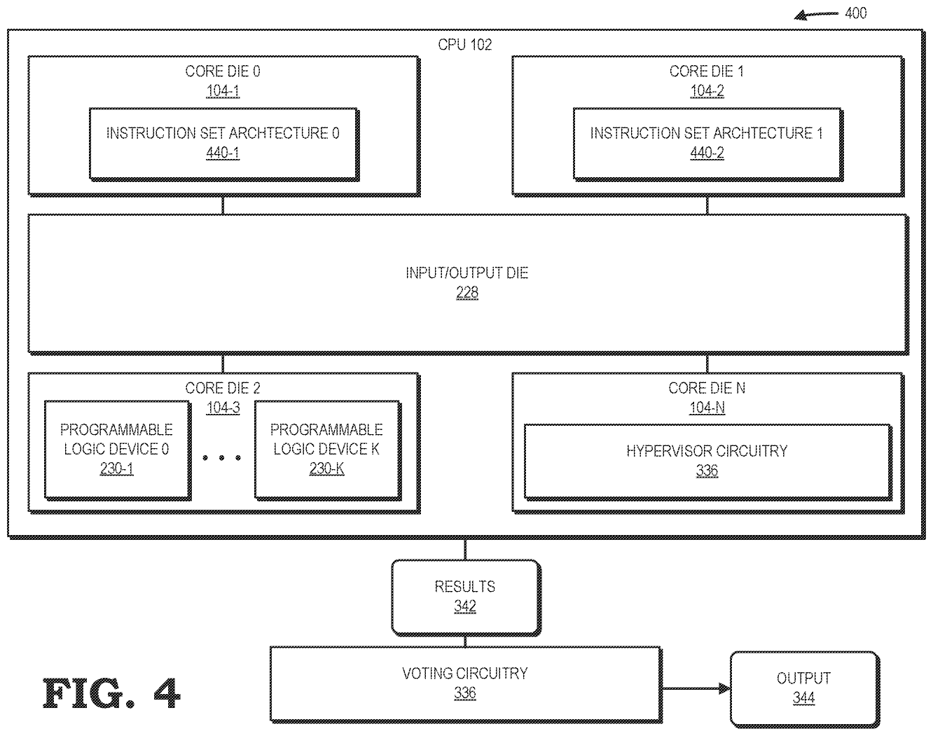

Referring now to FIG. 4, CPU 102 implementing an example N-way hardware redundant framework 400 is presented. Within N-way hardware redundant framework 400, CPU 102 includes one or more core dies 104 associated with one or more ISAs 440 (e.g., one or more cores 104 including processor cores 106, 108, 232 having an architecture associated with one or more ISAs 440), one or more core dies 104 that each including one or more programmable logic devices 230, or both. For example, CPU 102 includes a first core die 0 104-1 associated with a first ISA 0 440-1 (e.g., x86), a second core die 1 104-2 associated with a second ISA 1 440-2 (e.g., ARM), and a third core die 2 104-3 including one or more programmable logic devices 230 (e.g., FPGAs). Though the example implementation illustrated in FIG. 4 presents core die 2 104-3 as having two programmable logic devices (230-1, 230-K) representing a K number of programmable logic devices 230, in other implementations a core die 104 can include any number of programmable logic devices 230. According to implementations, hypervisor circuitry 336 is configured to allocate each core die 104 to a respective VM such that each core die 104 executes the same instructions, workloads, operations, or any combination thereof for an application executed by each of the VMs. In this way, each core die 104 is configured to execute the same instructions, workloads, operations, or any combination thereof for the same application concurrently. As such, CPU 102 is configured to execute the same instructions, workloads, operations, or any combination thereof for an application using different hardware (e.g., based on the core dies 104). For example, CPU 102 is configured to execute the same instructions, workloads, operations, or any combination thereof using core dies 104 associated with two or more different ISAs 440 (e.g., x86, ARM). Additionally, CPU 102 is configured to execute the same instructions, workloads, operations, or any combination thereof for an application using core dies 104 associated with one or more ISAs 440 (e.g., x86, ARM), having one or more programmable logic devices 230, or both.

In response to executing one or more instructions, workloads, operations, or any combination thereof for an application, each core die 104 is configured to provide results 342 (e.g., data resulting from the execution of the instructions, workloads, operations, or any combination thereof) to voting circuitry 338 included in or otherwise connected to CPU 102. That is to say, the core dies 104 provide results 342 from the execution of a same set of instructions, workloads, operations, or any combination thereof based on the hardware (ISAs 440, programmable logic devices) associated with the core dies 104. To determine an output 344, voting circuitry 338 (e.g., including a majority logic gate) is configured to determine a majority result from the received results 342 (e.g., the most frequently occurring, or mode, result within the received results 342), a minority result from the received results 342 (e.g., the least frequently occurring result within the received results 342), or both. In this way, CPU 102 implements an N-way hardware redundant framework 300 to help minimize errors, security vulnerabilities, or both introduced into processing system 100 by one or more ISAs 440. For example, in implementations, CPU 102 includes a first core die 0 104-1 associated with a first ISA 0 440-1 (e.g., x86), a second core die 1 104-2 associated with a second ISA 1 440-2 (e.g., ARM), and a third core die 2 104-3 including one or more programmable logic devices 230 (e.g., FPGAs) each configured to execute a same set of instructions for an application. In response to executing the set of instructions, each core die 104 is configured to provide the result (e.g., data resulting from the execution of the set of instructions) to voting circuitry 338. Voting circuitry 338 then determines a majority result (e.g., the most frequently occurring, or mode, result within the received results 342) to determine an output 344 for CPU 102. In this way, if one of the core dies 104 of CPU 102 provides an incorrect result due to one or more errors, security vulnerabilities, or both introduced by an ISA 440 associated with the core die 104, the voting circuitry still determines a correct output 344 by determining the majority result and disregarding the incorrect result caused by the ISA 440 introducing one or more errors, security vulnerabilities, or both.

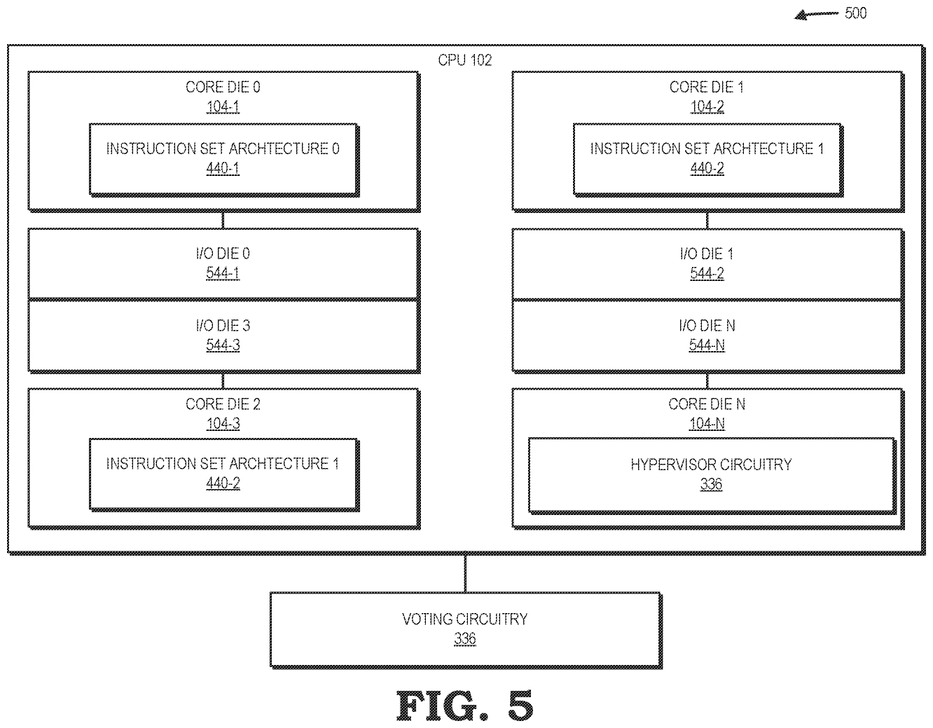

Referring now to FIG. 5, CPU 102 implementing an example N-way hardware redundant framework 500 is presented. Within N-way hardware redundant framework 500, CPU 102 includes one or more core dies 104 associated with one or more ISAs 440 (e.g., one or more cores 104 including processor cores 106, 108, 232 having an architecture associated with one or more ISAs 440). For example, CPU 102 includes a first core die 0 104-1 associated with a first ISA 0 440-1 (e.g., x86), a second core die 1 104-2 associated with a second ISA 1 440-2 (e.g., ARM), and a third core die 2 104-3 associated with the second ISA 1 440-2 (e.g., ARM). According to implementations, hypervisor circuitry 336 is configured to allocate each core die 104 to a respective VM such that each core die 104 executes the same instructions, workloads, operations, or any combination thereof for an application executed by each of the VMs. In this way, each core die 104 is configured to execute to the same instructions, workloads, operations, or any combination thereof for the same application concurrently. As such, CPU 102 is configured to execute the same instructions, workloads, operations, or any combination thereof for an application using different hardware (e.g., based on the core dies 104). For example, CPU 102 is configured to execute the same instructions, workloads, operations, or any combination thereof using core dies 104 associated with two or more different ISAs 440 (e.g., x86, ARM).

To support the execution of one or more instructions, workloads, operations, or any combination thereof of an application by core dies 104, CPU 102 includes a respective I/O die 544, similar to or the same as I/O die 228, for one or more core dies 104 of CPU 102. For example, CPU 102 includes a respective I/O die 544 connected to each core die 104 of CPU 102. In some implementations, each I/O die 544 includes a separate and distinct die while in other implementations, each I/O die 544 is formed by a partition of a larger I/O die (e.g., I/O die 228). Though the example implementation presented in FIG. 5 presents CPU 102 including four I/O dies (544-1, 544-2, 544-3, 544-N) representing an N number of I/O dies 544, in other implementations, CPU 102 may have any number of I/O dies 544. For example, in implementations, CPU 102 has an I/O die 544 for each core die 104 of the CPU 102.

According to implementations, each I/O die 544 is associated with (e.g., connected to) a respective core die 104. For example, a first I/O die 0 544-1 is associated with a first core die 0 104-1, a second I/O die 1 544-2 is associated with a second core die 1 104-2, a third I/O die 2 544-3 is associated with a third core die 2 104-3, and a fourth I/O die 544-N is associated with a fourth core die N 104-N. Further, each I/O die 544 includes hardware-based circuitry, software-based circuitry, or both configured to provide an interface between a respective core die 104 and memory 118, one or more I/O devices 120, or both. For example, each I/O die 544 includes or is otherwise connected to a respective data fabric 224 to provide an interconnect architecture between a respective core die 104, memory 118, one or more I/O devices 120, bus 101, or any combination thereof. Additionally, to provide an interface between a core die 104 and memory 118, each I/O die 544 includes a respective memory controller 226 configured to access, modify, and delete data in memory 118. Further, to provide an interface between a respective core die 104 and one or more I/O devices 120, each I/O die 544 includes one or more respective I/O controllers 222 configured to manage data transfers (e.g., memory access requests) between a respective core die 104, memory 118, and one or more I/O devices 120. Because each core die 104 interfaces with memory 118 and I/O devices 120 by a respective I/O die 544, processing system 100 is able to partition memory 118 and I/O devices 120 such that only respective partitions of memory 118 and I/O devices 120 are accessible by certain core dies 104. Due to such partitioning, the level of redundancy in processing system 100 is improved, reducing the likelihood of an operating system 112, ISA, or both introducing further errors, security vulnerabilities, or both into processing system 100 and increasing the reliability of processing system 100.

Additionally, in implementations, each I/O die 544 is associated with an ISA (e.g., ISA 440). That is to say, each I/O die 544 has an architecture based on an ISA such that the I/O die 544 is configured to perform one or more operations (e.g., memory ordering, interrupt delivery, I/O device control, input-output memory management unit (IOMMU) implementations, root complex interactions, memory interactions) according to the ISA. According to implementations, each I/O die 544 is associated with the same ISA as the core die 104 associated with the I/O die 544. For example, I/O die 0 544-1 associated with core die 0 104-1 is associated with ISA 0 440-1. In this way, each I/O die 544 is configured to support each core die 104 when two or more core dies 104 are associated with different ISAs (e.g., x86, ARM).

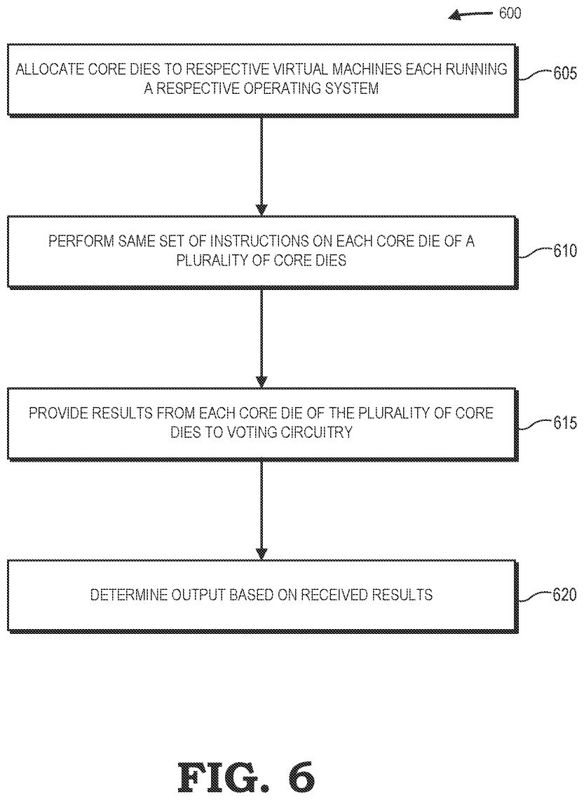

Referring now to FIG. 6, an example method 600 for implementing N-way fault tolerance is presented. In implementations, method 600 includes CPU 102 having one or more core dies 104 each associated with a respective ISA 440 (e.g., having one or more processor cores 106, 108, 232 associated with a respective ISA 440), one or more core dies 104 having programmable logic devices 230 (e.g., FPGAs), or both. Additionally, CPU 102 includes a core die 104 including hypervisor circuitry 336 (e.g., one or more processing cores 106, 108, 232 executing one or more instructions to create and manage VMs). At step 605, hypervisor circuitry 336 is configured to allocate two or more core dies 104 of CPU 102 to respective VMs executed by processing system 100. In implementations, each VM executed by processing system 100 executes a same application and runs a respective operating system 112 with two or more VMs executed by processing system 100 running different operating systems 112. As an example, hypervisor circuitry 336 is configured to allocate a first core die 104 to a first VM running a first operating system 112, a second core die 104 to a second VM running a second operating system 112, and a third core die 104 to a third VM running a third operating system 112, wherein the first, second, and third operating system 112 are each different from one another. As another example, hypervisor circuitry 336 is configured to allocate a same operating system to two or more core dies 104 each associated with different ISAs 440. As yet another example, hypervisor circuitry 336 is configured to allocate a first core die 104 associated with a first ISA 440 to a first VM running a first operating system 112 and a second core die 104 associated with a second ISA 440 to a second VM running a second operating system 112, wherein the first ISA 440 is different from the second ISA 440 and wherein the first operating system 112 is different from the second operating system 112.

At step 610, in response to being allocated to the VMs, the core dies 104 are configured to perform a set of instructions, workloads, operations, or any combination thereof for a same application executed by processing system 100, a respective VM (e.g., the VM to which a core die 104 was allocated), or both. That is to say, the processor cores 106, 108, 232 of each core die 104 perform a set of instructions, workloads, operations, or any combination thereof for a same application executed by processing system 100, a respective VM, or both. In this way, the core dies 104 execute a set of instructions, workloads, operations, or any combination thereof using two or more operating systems 112, two or more ISAs 440, or both. At step 615, after executing the set of instructions, workloads, operations, or any combination, each core die 104 provides results 342 (e.g., data resulting from the execution of the instructions, workloads, operations, or any combination thereof) to voting circuitry 336. Such results 342, for example, represent the concurrent execution of the same set of instructions, workloads, operations, or any combination thereof according to two or more operating systems 112, ISAs 440, or both (e.g., according to the operating systems 112 and ISAs 440 associated with the core dies 104).

At step 620, in response to receiving the results 342 from the core dies 104, voting circuitry 336 is configured to determine an output 344 of CPU 102 based on, for example, the received results 342. For example, to determine an output 344 of CPU 102, the voting circuitry (e.g., including a majority logic gate) is configured to determine a majority result from the received results 342 (e.g., the most frequently occurring, or mode, result within the received results), a minority result from the received results 342 (e.g., the least frequently occurring result within the received results), or both. In this way, CPU 102 implements N-way fault tolerance to help minimize errors, security vulnerabilities, or both introduced into processing system 100 by one or more operating systems 112, ISAs, or both.

In some implementations, the apparatus and techniques described above are implemented in a system including one or more integrated circuit (IC) devices (also referred to as integrated circuit packages or microchips), such as the CPU described above with reference to FIGS. 1-6. Electronic design automation (EDA) and computer-aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer-readable storage medium accessible to the computing system. Likewise, the code representative of one or more phases of the design or fabrication of an IC device may be stored in and accessed from the same computer-readable storage medium or a different computer-readable storage medium.

A computer-readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer-readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some implementations, certain aspects of the techniques described above may be implemented by one or more processors of a processing system executing software. The software includes one or more sets of executable instructions stored or otherwise tangibly embodied on a non-transitory computer-readable storage medium. The software can include the instructions and certain data that, when executed by the one or more processors, manipulate the one or more processors to perform one or more aspects of the techniques described above. The non-transitory computer-readable storage medium can include, for example, a magnetic or optical disk storage device, solid-state storage devices such as Flash memory, a cache, random access memory (RAM), or other non-volatile memory device or devices, and the like. The executable instructions stored on the non-transitory computer-readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still, further, the order in which activities are listed is not necessarily the order in which they are performed. Also, the concepts have been described with reference to specific implementations. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific implementations. However, the benefits, advantages, solutions to problems and any feature(s) that may cause any benefit, advantage, or solution to occur or become more pronounced are not to be construed as a critical, required, or essential feature of any or all the claims. Moreover, the particular implementations disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular implementations disclosed above may be altered or modified and all such variations are considered within the scope of the disclosed subject matter. Accordingly, the protection sought herein is as set forth in the claims below.

What is claimed is:

1. A processor comprising:
a first core die associated with a first operating system and including one or more processor cores, wherein the one or more processor cores of the first core die are configured to execute an instruction to produce a first result;
a second core die associated with a second operating system and including one or more processor cores, wherein the one or more processor cores of the second core die are configured to execute the instruction to produce a second result and wherein the second operating system is different from the first operating system; and
a voting circuitry configured to generate an output based on the first result and the second result.

2. The processor of claim 1, further comprising:
a third core die associated with a third operating system and including one or more processor cores, wherein the one or more processor cores of the third core die are configured to execute the instruction to produce a third result.

3. The processor of claim 2, wherein the voting circuitry is configured to generate the output based upon the first result, the second result, and the third result.

4. The processor of claim 1, wherein:
the one or more processor cores of the first core die are associated with a first instruction set architecture (ISA);
the one or more processor cores of the second core die are associated with a second ISA; and
the second ISA is different from the first ISA.

5. The processor of claim 4, further comprising:
a first input/output (I/O) die associated with the first ISA and connected to the first core die; and
a second I/O die associated with the second ISA and connected to the second core die.

6. The processor of claim 1, further comprising:
a third core die including one or more programmable logic devices.

7. The processor of claim 1, further comprising:
a third core die including one or more processor cores configured to:
allocate the first core die to a first virtual machine (VM) running the first operating system; and
allocate the second core die to a second VM running the second operating system.

8. A method comprising:
executing, on a first core die of a processor, an instruction to produce a first result, wherein the first core die is associated with a first operating system;
executing, on a second core die of the processor, the instruction to produce a second result, wherein the second core die is associated with a second operating system and wherein the second operating system is different from the first operating system; and
generating an output based on the first result and the second result.

9. The method of claim 8, wherein the instruction is executed on the first core die and the second core die concurrently.

10. The method of claim 8, further comprising:
executing, on a third core die of the processor, the instruction to produce a third result, wherein the third core die is associated with a third operating system and wherein the output is generated based on the first result, the second result, and the third result.

11. The method of claim 8, wherein:
the first core die includes one or more processor cores associated with a first instruction set architecture (ISA);
the second core die includes one or more processor cores associated with a second ISA; and
the second ISA is different from the first ISA.

12. The method of claim 8, further comprising:
allocating the first core die to a first virtual machine (VM) running the first operating system; and
allocating the second core die to a second VM running the second operating system.

13. The method of claim 8, wherein the processor further comprises a third core die including one or more programmable logic devices.

14. A processor comprising:
a first core die including one or more processor cores associated with a first instruction set architecture (ISA), wherein the one or more processor cores of the first core die are configured to execute an instruction to produce a first result;
a second core die including one or more processor cores associated with a second ISA, wherein the one or more processor cores of the second core die are configured to execute the instruction to produce a second result and wherein the second ISA is different from the first ISA; and
a voting circuitry configured to generate an output based on the first result and the second result.

15. The processor of claim 14, wherein:
the first core die is associated with a first operating system;
the second core die is associated with a second operating system; and
the second operating system is different from the first operating system.

16. The processor of claim 15, further comprising:
a third core die including one or more processor cores configured to:
allocate the first core die to a first virtual machine (VM) running the first operating system; and
allocate the second core die to a second VM running the second operating system.

17. The processor of claim 14, further comprising:
a first input/output (I/O) die associated with the first ISA and connected to the first core die; and
a second I/O die associated with the second ISA and connected to the second core die.

18. The processor of claim 14, further comprising:
a third core die including one or more programmable logic devices.

19. The processor of claim 18, wherein the one or more programmable logic devices includes one or more field-programmable gate arrays.

20. The processor of claim 14, wherein the one or more processor cores of the first core die and the one or more processor cores of the second core die are configured to execute the instruction concurrently.
